(19) United States
(12) Patent Application Publication
(10) Pub. No.: US 2015/0251930 A1
(43) Pub. Date: Sep. 10, 2015

(54) Differential reverse osmosis method and apparatus

(71) Applicant: newterra Itd., Brockville (CA)

(72) Inventors: Kevin Dufresne, Hamilton (CA); Jason Downey, Ottawa (CA)

(21) Appl. No.: 14/632,867

(22) Filed: Feb. 26, 2015

Related U.S. Application Data
(60) Provisional application No. 61/948,078, filed on Mar. 5, 2014.
(60) Provisional application No. 62/047,933, filed on Sep. 9, 2014.

(51) Int. Cl. C02F 1/44; C02F 1/42; C02F 1/52; C02F 1/00

(52) U.S. Cl. CPC C02F 1/441; C02F 1/008; C02F 1/42; C02F 1/52; C02F 2103/08

(57) ABSTRACT

A system for treating water has a plurality of concatenated reverse osmosis (RO) units, each having a membrane. Water to be treated is fed to one side of the membrane at a pressure to overcome osmotic pressure across the membrane and to force permeate to the other side of the membrane. The water on the one side of the membrane retains dissolved solids to become concentrate. Concentrate from a downstream RO unit is directed to the other side of the membrane of the upstream RO unit to mix the directed concentrate from the downstream RO unit with the permeate of the upstream RO unit. The mixed concentrate and permeate from the upstream unit is then treated at the downstream RO unit.

### CROSS REFERENCE TO RELATED PATENTS

The present application claims priority under 35 USC 119(e) to the provisionally filed application entitled “Differential reverse osmosis method and apparatus”, having Ser. No. 61/948,078, filed on Mar. 5, 2014, and the provisionally filed application entitled “Differential reverse osmosis method and apparatus”, having Ser. No. 62/047,933 filed on Sep. 9, 2014, the contents of which applications are incorporated herein by reference thereto.

### FIELD OF THE INVENTION

This invention relates to a method and apparatus for treating water, with particular but not exclusive application to treating water such as seawater, produced or flowback water having high levels of dissolved solids.

### BACKGROUND

Osmosis is a process in which solvent moves from a region of low solute concentration through a membrane to a region of high solute concentration. Solvent movement is driven by the tendency for a system's available free energy to be lowered by equalizing solute concentration either side of the membrane, thereby generating osmotic pressure.

In reverse osmosis (RO), an external pressure is applied to reverse this flow of pure solvent. When used for water purification, pressure is applied to a water feed to push the water through a membrane which blocks passage of dissolved large molecules and ions but freely allows passage of smaller components such as solvent molecules. The RO process separates the feed solution into permeate, which passes through the membrane, and concentrate which is richer in the dissolved constituents than the initial feed water and is prevented from passing through the membrane. RO separation efficiency depends on solute concentration in the feed, applied pressure, and the rate at which the pure solvent permeates through the membrane. The accepted measure of a RO system's efficiency is expressed by its percentage recovery, being (permeate flow rate÷feed flow rate)×100.

The presence of dissolved solids in the feed water on one side of the membrane and nominally pure water on the other side of the membrane results in an osmotic pressure that must be exceeded in order to drive a reverse flow through the RO unit. Generally, increasing concentration of dissolved solids in the feed water causes increasing osmotic pressure which, in turn means that greater feed pressure is required at the RO unit. For water having a high level of dissolved solids, the osmotic pressure is correspondingly large and this limits the achievable throughput of pure permeate. For example, the recovery of a seawater purification plant is limited typically to about 50% in order not to exceed the physical pressure limits of the membrane element and associated equipment, to limit the energy consumption required by application of high pressure to the feed solution, and to limit the dissolved solids content in the resulting permeate.

For desalinated water, obtaining higher purity generally translates to the need for more equipment and more energy. Water purity expressed as total dissolved solids (TDS) typically varies from 70 to 400 parts per million (ppm or milligram/liter) for fresh water sources. A level of 500 ppm is generally accepted as the upper limit for drinking water, while the US Food and Drug Administration classify mineral water as water containing at least 250 ppm.

In a seawater RO unit, the seawater may have a salt content of the order of 35000 milligrams per liter. In subjecting this to a RO process, a pressure of the order of 1000 pounds per square inch (PSI) is required. Of this, about 60% acts to overcome the osmotic pressure and 40% acts to push the water through the membrane. To produce such a pressure in industrial and municipal scale seawater reverse osmosis (SWRO) plants requires high horsepower pumps and steel pipes. Steel pipes and associated steel pump elements may be subject to corrosion by the seawater. Because pipes of non-corrosive materials such as plastic materials tend not to be strong enough to withstand such pressures, expensive non-corroding alloy materials have been used for pipework and pump elements in such plants.

It would be valuable to be able to use cheaper materials for large scale RO installations such as those used for purifying seawater and for remediating contaminated water from hydraulic fracturing operations.

### SUMMARY OF THE INVENTION

According to one aspect of the invention, there is provided a water treatment system comprising a plurality of concatenated reverse osmosis (RO) units each RO unit having a RO membrane, each unit having a feed input of water to be treated to one side of the associated membrane, a sub-system for applying RO pressure to the feed water to produce a concentrate at said one side of the membrane and permeate at the other side of the membrane, and a circuit configured to direct concentrate from the one side of at least one downstream RO unit membrane to the other side of an upstream RO unit membrane to mix the directed concentrate from the downstream RO unit with the permeate of the upstream RO unit at the other side of the upstream RO unit, and to direct the mixed concentrate and permeate from the upstream RO unit as the feed input to the downstream RO unit.

According to another aspect of the invention, there is provided a method for treating water using a plurality of concatenated reverse osmosis (RO) units, each RO unit having a RO membrane, the method comprising at each RO unit, feeding a feed input of water to be treated to one side of the associated membrane, applying RO pressure to the feed water to produce concentrate at said one side of the membrane and permeate at the other side of the membrane, and directing concentrate from the one side of at least one downstream RO unit to the other side of the membrane of an upstream RO unit to mix the directed concentrate from the downstream RO unit with the permeate of the upstream RO unit, and directing at least a part of the mixed concentrate and permeate as the feed input to the downstream RO unit.

According to further aspect of the invention, there is provided a reverse osmosis (RO) unit comprising a plurality of envelopes formed from RO membranes, first passage members between adjacent envelopes defining first passages, second passage members inside the envelopes defining second passages, a series of such envelopes and the passage members associated therewith mounted on a support structure, a first feed water inlet for directing a primary feed water under pressure into the first passages to drive permeate from the primary feed water across the RO membrane into the second passages, a second feed water inlet for directing a secondary feed water into the second passages to mix with permeate crossing the RO membrane, and an outlet for directing the mixed permeate and secondary feed water from the RO unit.

Preferably, the envelopes and the passage members are wound in overlapping relationship around an outer surface of a least one tube so that interiors of the envelopes are in fluid communication with holes formed in a wall of the at least one tube. The at least one tube can be a single tube, the tube having an inlet section and an outlet section, with some of the holes in the inlet section and other of the holes in the outlet section, and a barrier between the tube inlet and outlet sections. Each envelope can have a plurality of interior channels extending between the tube inlet section and the tube outlet section. The first passages can extend on said one side of the membrane from the first feed water inlet at one end of the RO unit to a concentrate outlet at the other end of the RO unit.

Each of the channels can have at least a part extending on said other side of the membrane in a direction generally counter to the first feed water direction of flow from said one end of the RO unit to the other end of the RO unit. The RO unit can have a first passage extending in a first feed direction, a set of the channels interfacing with the first passage across the membrane and extending in a direction generally opposite to the first feed direction, the length of the interface being substantially equal as between the several channels. In such a structure, the channels at the outlet section can in aggregate have a cross-sectional area greater than the aggregate cross-sectional area of the inlet section. In such a structure, adjacent channels of the set of channels can be nested over the area of the envelope.

The RO unit can be of generally cylindrical form with the membrane contained in a pressure vessel having an inlet for the primary feed water and an outlet for the mixed permeate and secondary feed water.

According to a further aspect of the invention, there is provided a method of operating a RO unit having a plurality of envelopes formed from RO membranes, first passage members between adjacent envelopes defining first passages and second passage members inside the envelopes defining second passages, the plurality of envelopes and the passage members associated therewith mounted on a support structure, the method comprising directing a primary feed water under pressure into the first passages to drive permeate from the primary feed water across the RO membrane into the second passages, directing a secondary feed water into the second passages to mix with permeate crossing the RO membrane, and directing the mixed permeate and secondary feed water from the RO unit. Preferably, the method further compress directing the primary feed water at one side of the membrane of said membrane envelope over a first route and directing the secondary feed water at the other side of the membrane of said membrane envelope over a second route, the first and second routes over at least part of their length being counter to one another.

According to a further aspect of the invention, for a reverse osmosis (RO) unit, there is provided a RO structure having a RO membrane, a feed water passage having an interface with one side of the membrane, a feedback water passage having an interface with the other side of the membrane, a feed water inlet configured for directing the feed water under pressure along the feed water passage so that, in use, at least some of the feed water is driven as permeate across the RO membrane into the feedback passage, and a feedback water inlet configured for directing feedback water along the feedback water passage so that the fed back water receives permeate crossing the RO membrane into the feedback passage, the overall flow of the feed water being in a direction generally counter to the overall flow direction of the feedback water. Preferably, the RO membrane is in the form of an envelope, a bounding container contains the envelope, at least one feedback water passage is located inside the envelope, at least one feedback water passage is located between the bounding container and the exterior of the envelope, and the structure includes an outlet for directing the mixed permeate and fed back water from the RO unit. Preferably, the envelope has two membranes spaced apart by a spacer mesh, the at least one feedback water passage being a channel in the spacer mesh, the channel bounded by the two membranes.

### BRIEF DESCRIPTION OF THE DRAWINGS

For simplicity and clarity of illustration, elements illustrated in the following figures are not drawn to common scale. For example, the dimensions of some of the elements are exaggerated relative to other elements for clarity. Advantages, features and characteristics of the present invention, as well as methods, operation and functions of related elements of structure, and the combinations of parts and economies of manufacture, will become apparent upon consideration of the following description and claims with reference to the accompanying drawings, all of which form a part of the specification, wherein like reference numerals designate corresponding parts in the various figures, and wherein:

FIG. 1 is a schematic process flow diagram of a known form of RO water purifying system.

FIG. 2 is a graphical representation of a known RO water purifying system showing the relationship between feed pressure, osmotic pressure and permeate flow.

FIG. 3 is a schematic process flow diagram of a RO water purifying system according to an embodiment of the invention.

FIG. 4 is a graphical representation of system of FIG. 3 showing the relationship between feed pressure, osmotic pressure and permeate flow.

FIG. 5 shows part of a RO unit for use in the system of FIG. 3.

FIG. 6 is a cross-section of the RO unit of FIG. 5.

FIG. 7 shows a permeate tube and membrane envelope forming parts of the RO unit of FIG. 5, the membrane envelope shown in an unrolled configuration.

FIG. 8 shows an alternative configuration according to an embodiment of the invention of a permeate tube and membrane envelope forming parts of the RO unit of FIG. 5, the membrane envelope shown in an unrolled configuration.

FIG. 9 shows a further alternative configuration according to an embodiment of the invention of a permeate tube and membrane envelope forming parts of the RO unit of FIG. 5, the membrane envelope shown in an unrolled configuration.

FIG. 9A is a perspective view showing part of a known form of membrane spacer.

FIG. 9B is a section view of a modified form of the membrane spacer of FIG. 9A according to an embodiment of the invention.

FIG. 10 is a schematic process flow diagram of a RO water purifying system according to another embodiment of the invention.

FIG. 11 is a schematic process flow diagram of a RO water purifying system according to another embodiment of the invention, the system having one form of pre-treatment sub-system.

FIG. 12 is a schematic process flow diagram of a RO water purifying system according to another embodiment of the invention, the system having an alternative form of pre-treatment sub-system.

### DETAILED DESCRIPTION OF THE INVENTION INCLUDING THE PRESENTLY PREFERRED EMBODIMENTS

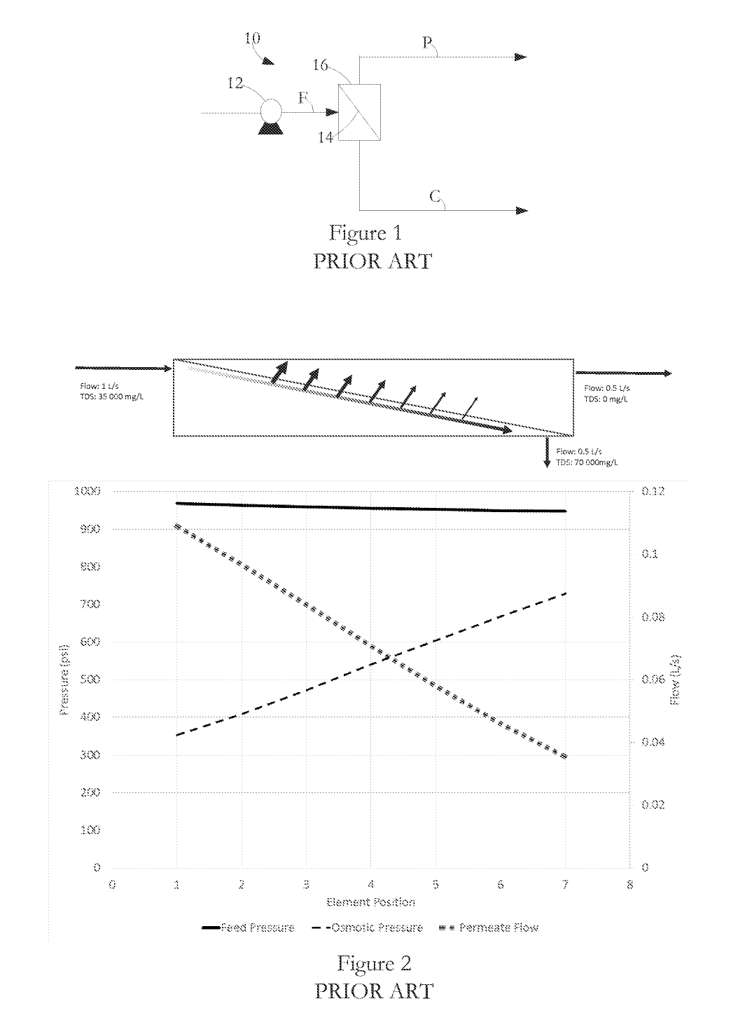

Referring to FIG. 1, a known form of RO system 10 for purifying water has a pump 12 for pumping the water feed F under high pressure across a membrane 14 housed in a pressure vessel 16. The applied pressure has a first component which overcomes the prevailing osmotic pressure developed across the membrane 14 arising from the difference in dissolved solids concentration as between the feed side and the permeate side of the membrane. A residual component of the applied pressure drives nominally pure water permeate P across the membrane. Dissolved solids blocked from crossing the membrane causes the total dissolved solids (TDS) concentration of the water on the feed side of the membrane to become more concentrated as the feed flows through the unit and is piped off as concentrate C. In the RO unit depicted in FIG. 1, a water feed F, such as seawater, is delivered to the RO unit membrane at a rate of 1 liter per second and a TDS concentration of 35000 milligrams per liter. The feed is separated into a nominally pure water permeate P at the far side of the membrane at a flow rate of 0.5 liters per second and a concentrate C at the output end of the feed side of the RO unit at a flow rate of 0.5 liters per second and a TDS concentration of 70000 milligrams per liter. This model assumes 100% rejection of dissolved solids from the seawater feed. In fact, some smaller molecules can be expected to traverse the membrane 14.

Operation of the unit requires a very high applied pressure to overcome the prevailing osmotic pressure between a feed water such as seawater on the feed side of the membrane 14 and the nominally pure water on the permeate side of the membrane. In the graphical representation of FIG. 2, the top graph represents the changing composition of the feed water as it passes along the length of the RO unit and the changing amount of permeate passing through the membrane as a function of length along the RO unit. The lower graph, drawn on the same length axis as the upper graph, illustrates the feed pressure at a high, approximately constant level of about 960 p.s.i. over the length of the RO unit. As the feed moves through the RO unit, the concentration of dissolved solids increases owing to the loss of nominally pure water solvent across the membrane. As the TDS on the feed side of the membranes increases along the length of the RO unit, the osmotic pressure correspondingly increases from about 360 p.s.i. to about 725 p.s.i., while permeate flow decreases from about 0.11 L/s near the entrance of the RO unit to about 0.04 L/s near the RO unit exit end for a feed of 1 liter per minute. At the input end of the RO unit, a relatively smaller component of the applied pressure is used to overcome the osmotic pressure, so a relatively larger pressure component is available to force nominally pure water across the membrane which means that the rate of permeate crossing the membrane is high at the input end. In contrast, at the output end, a larger applied pressure component is used to overcome the higher osmotic pressure and, therefore, a smaller pressure component is available to force water across the membrane resulting in a low rate of permeate crossing the membrane.

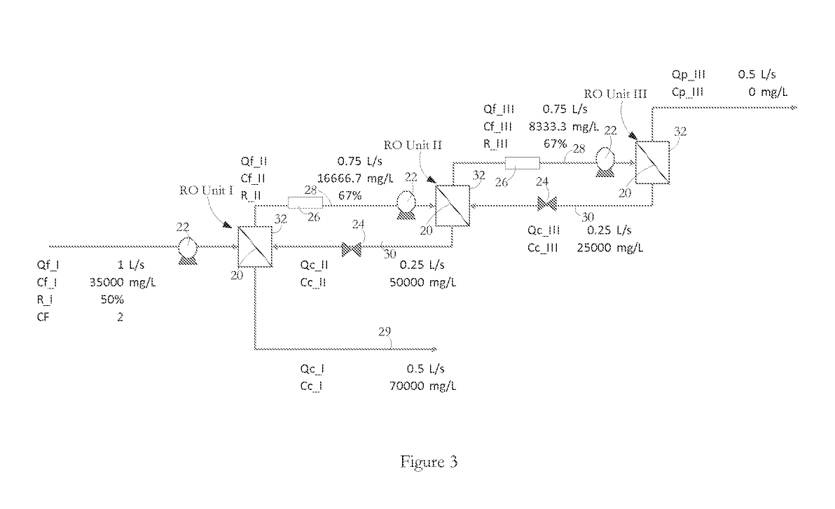

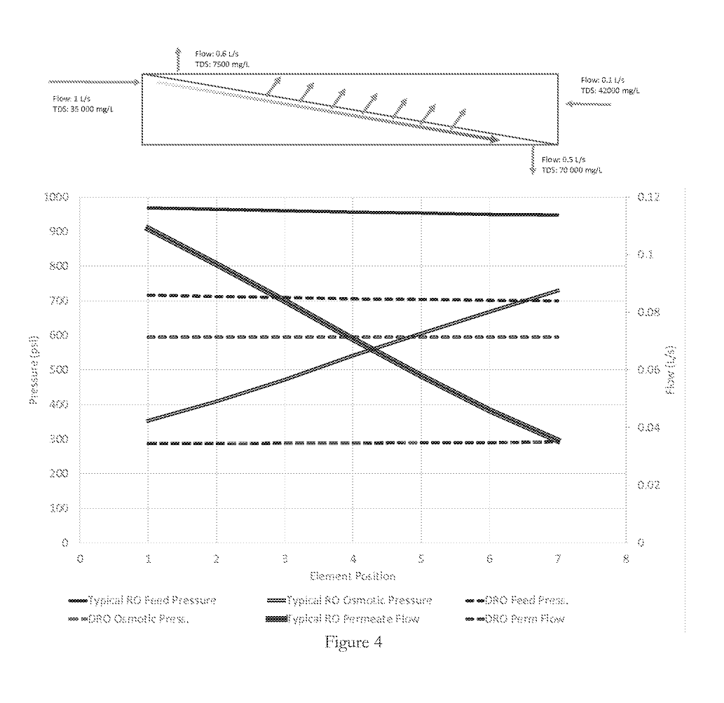

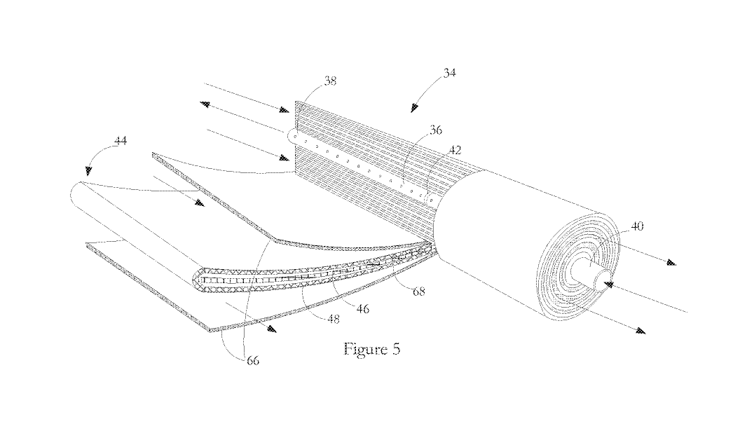

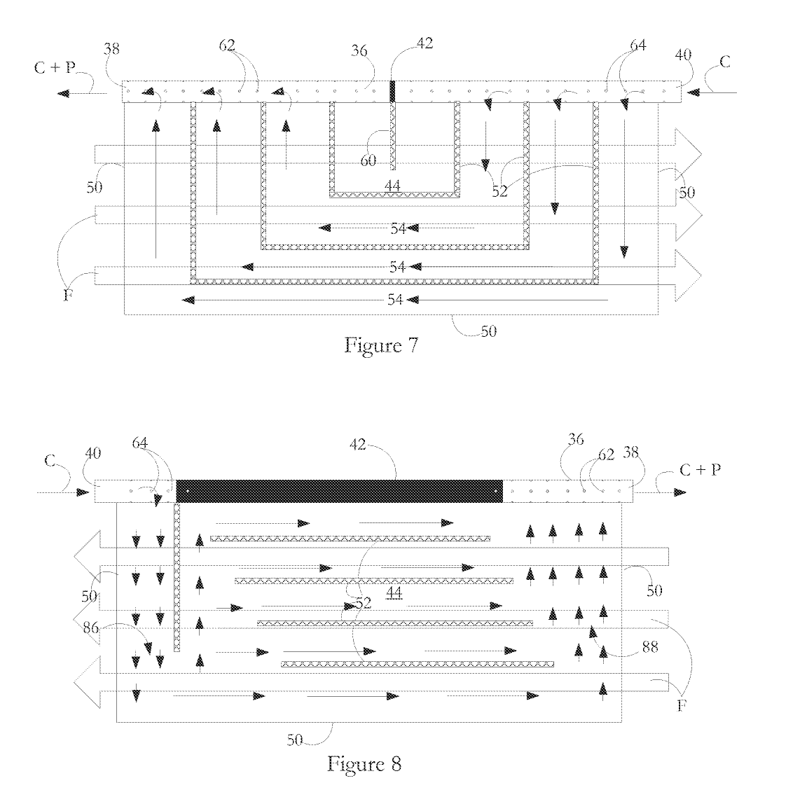

Referring in detail to FIG. 3, a differential RO water treatment system according to an embodiment of the invention has multiple RO units, each having a membrane 20 mounted in a pressure vessel 32. Associated with the RO units 18 are high pressure pumps 22, control valves 24 and buffer tanks 26. These system components are connected by pipe links 28, 30. At each RO unit 18, feed water to be treated enters the unit on the feed side of the membrane 20 and, as seen more clearly in FIGS. 5 and 7, at the feed end of the RO unit. Permeate from the feed water flows under the influence of RO pressure across the membrane 20 to the permeate side. Dissolved solids in the feed are blocked from passing across the membrane 20 and so accumulate as concentrate at the other end of the RO unit. The feed to the first RO unit I in this exemplary implementation is seawater.

The RO units are interconnected such that permeate from an upstream RO unit such as RO unit I, flows through links 28 to become part of the feed for the immediately downstream RO unit, such as RO unit II. By concatenating a series of RO units 18, the total reverse osmotic pressure required to drive the seawater at its initial high concentration of impurity to obtain nominally pure water permeate at a desired level of purification at RO unit III is divided over several RO units. Because the separation of dissolved solids from permeate is done at a series of concatenated units, the separation is incremental rather than drastic.

The concentrate developed at the output end of the first RO unit I is piped away and discarded or used in the extraction of dissolved solids as shown at 29. However, connections 30 between downstream RO units are configured for feeding concentrate from each of the downstream RO units at a pre-set flow rate back to the permeate side of the immediately preceding upstream RO unit, where it is mixed with the permeate of that upstream RO unit. The mixing occurs adjacent the membrane of the upstream RO unit so as to increase the TDS of the water on the permeate side. For a given TDS on the feed side of the membrane, the mixing of concentrate from the downstream RO unit with the permeate of the upstream RO unit acts to reduce the osmotic pressure acting across the upstream RO unit membrane. By adjusting the flow of fed back concentrate, the osmotic pressure gradient across the membrane of the upstream RO unit can be adjusted to a desired value.

The amount of concentrate returned from the downstream RO unit to the upstream RO unit determines the osmotic pressure gradient at the upstream unit, being set by the difference between dissolved solids concentration on the feed side of the membrane and dissolved solids concentration on the permeate side of the membrane. The feed side dissolved solids concentration is based on input water quality and cannot easily be changed. But the concentration on the permeate side of a particular RO unit can be readily changed to control the osmotic pressure gradient of that RO unit.

In FIG. 3,
Q=Flow (L/s)
C=Concentration (aka TDS, mg/L)
R=Recovery (%)
f=feed
c=concentrate
p=permeate
I=first phase
II=second phase
Etc.
   So, for example, Cf_II, is the concentration of the feed water to the second phase.

FIG. 4 is a graphical illustration of the operation of RO unit I of the FIG. 3 system. In the lower graph, broken lines show the operation of the FIG. 3 system while, for comparison, the full lines show the operation of the FIG. 1 system. Seawater having a TDS content of 35,000 mg/L is pumped to the feed side and the feed end of RO unit I. A flow of concentrate from the downstream RO unit II is pumped to the permeate side of RO unit I and is mixed with permeate crossing the membrane from the feed side of RO unit I. The concentrate from RO unit II has a TDS content of 50,000 mg/L. For a flow of 1 liter per second of seawater, the flow rate of the concentrate from RO unit II is set at 0.25 liters per second. At the outlet end of RO unit I, assuming full rejection of dissolved solids from the seawater feed, concentrate at a flow rate of 0.5 liters per second and a TDS of 70,000 mg/L is removed. Because of the injection of the controlled amount of concentrate from the RO unit II into the permeate side of the RO unit I, the osmotic pressure across the membrane of RO unit I is lowered compared with the system illustrated in FIG. 1. The injection of concentrate from RO unit II also alters the composition of the permeate side of RO unit I which becomes the feed to RO unit II. As illustrated, for the 1 liter volume of seawater per second pumped to RO unit I, the output from the permeate side of RO unit I of 0.75 liters per second is produced, this being made up of 0.5 liters per second of water crossing the membrane and 0.25 liters per second of concentrate fed back from RO unit II. This output becomes the feed input to RO unit II, having a flow rate of 0.75 liters per second and a TDS of 16,666.7 mg/L. A corresponding injection of concentrate is fed back from RO unit III into the permeate side of RO unit II with corresponding flow rates and TDS content as illustrated in FIG. 3.

The difference in TDS across the membranes of the RO units is configured so that there is little or no increase in osmotic pressure as the feed water passes along the unit from its input end to its output end. This means that a relatively uniform applied pressure results in a relatively uniform permeate flow regardless of the position along the RO unit. As illustrated in FIG. 4, the difference between feed concentration at the feed end of RO unit I (Cf_I), and the feed concentration at the feed end of RO unit II (Cf_II) determines the osmotic pressure at the feed end of the RO unit I. But since water is being pushed through the membrane of RO unit I, Cf_I is increasing along the length of the RO unit until it reaches a concentration level Cc_I at the exit end of RO unit I. This water enters the permeate side of RO unit I, which causes the concentrate component fed back from the downstream RO unit initially at a concentration of Cc_II to become more dilute until reaching a level Cf_II.

In an exemplary mode of operation, the permeate side of RO unit I is caused to undergo a change in dissolved solids concentration that generally parallels a change in concentration occurring along the feed side of RO unit I, so that the osmotic pressure is generally constant throughout the length of the RO unit: i.e. from the feed end to the concentrate end. To ensure that the concentration gradient along the length of the RO unit on the permeate side matches the concentration gradient along the length of the RO unit on the feed side, a particular flow rate is chosen depending on the TDS of the fed back concentrate. Alternatively, or in addition, a particular TDS concentration is chosen for the fed back concentrate by adjusting an outlet position or positions along the length of the membrane of the downstream unit from which the concentrate is taken.

In normal operation, for an initial feed water such as seawater having a roughly constant TDS content, dissolved solids concentration on the permeate side of each RO unit is kept at a target level. In practice, the concentration may slowly drift away from the target level owing to small molecules and ions leaking across the membrane from the feed side. In response, to maintain the concentration level, water on the permeate side may be purged to take away dissolved solids content or diluted by adding a less concentrated stream.

In a preferred embodiment, intermediate buffer tanks 26 in the links 28 facilitate flow control. Without them, the system would be closed-coupled which, while being more cost-effective, is more challenging in terms of achieving control.

A high pressure pump 22 in each link 28 provides the pressure needed to push water through the membranes 20 with a typical pressure, for brackish water, ranging from 225 to 375 psi (15.5 to 26 bar, or 1.6 to 2.6 MPa) and, for seawater, ranging from 800 to 1,180 psi (55 to 81.5 bar or 6 to 8 MPa). Even with a differential separation system, this requires a large amount of energy. Where energy recovery is used, all or part of the work of the high pressure pump may be done by energy recovery devices, thereby reducing the required system energy input.

At each RO unit, the membrane assembly typically consists of a pressure vessel 32 housing several membranes 18. Reverse osmosis membranes are made in a variety of configurations, with the two most common configurations being spiral-wound and hollow-fiber.

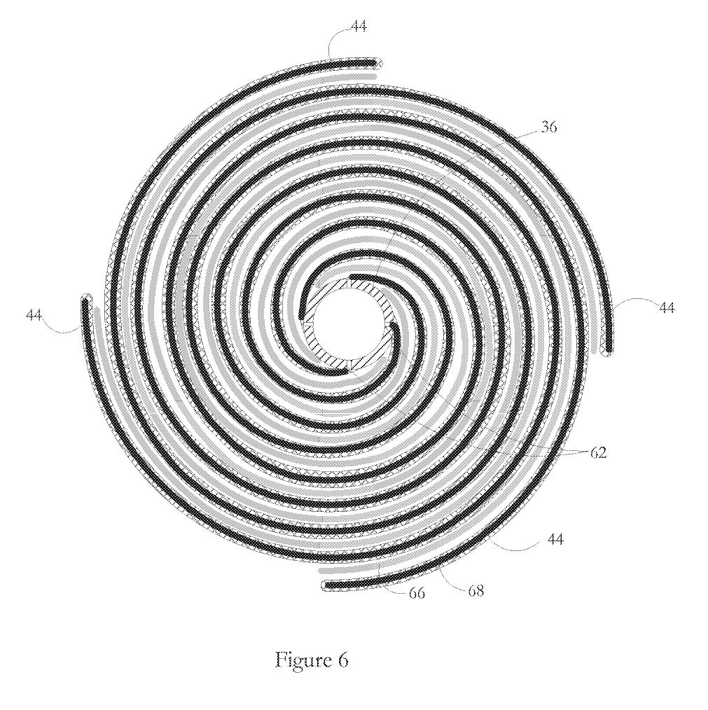

A spiral-wound RO unit 34 suitable for use in the phased separation method described previously is shown in FIGS. 5 to 7. The illustrated RO unit 34 has a central tube 36 having a water outlet section 38 and a water inlet section 40, the tube sections 38, 40 separated from each other by an internal barrier 42. The RO unit has a series of four membrane envelopes 44 (FIG. 6), each of the envelopes being generally rectangular in shape (FIGS. 5 and 7) with front and back membranes 46, 48 of the envelope 44 sealed together at three edges 50 (FIG. 7) but not at the fourth.

As shown in FIG. 7, the front and back membranes 46, 48 are welded to each other at regions 52 to provide separate channels or passages 54, the passages being generally rectilinear in form. The passages 54 extend from a region where the fourth membrane edges are sealed to the tube inlet section 40 to a region where the fourth membrane edges are sealed to the tube outlet section 38. The passages 54 are nested next to one another and around a central barrier weld 60. The tube has four rows of holes 62, 64 in its wall, one row being shown in FIG. 5. As shown in FIG. 6, the membrane envelopes 44 are fixed along their open sides to the tube 36 so that the holes 62, 64 are aligned with open ends of the passages 54, and the interiors of the passages 54 are consequently in fluid communication with the interior of the tube 36.

As shown in FIGS. 5 and 6, a leaf-form member 66 is positioned between each pair of adjacent membrane envelopes 44, the members 66 serving to keep the membrane envelopes 44 spaced from one another. The spacer members 66 are configured as plastic meshes which define void spaces (not shown) to provide passages along which feed water can flow. The meshes are flexible but resistant to compressive forces. Another form of leaf-form member 68 is positioned inside each membrane envelope 44, the members 68 serving to keep front and back sections of the membranes 46, 48 at each channel 54 spaced from one another. The spacer members 68 are also configured as flexible incompressible meshes having void spaces (not shown) to provide passages within which permeate water can circulate. The members 68 generally have a looser mesh weave than the members 66. The envelopes 44 and the spacer members 66, 68 are flexible and are wound as a roll onto the tube 36 as shown in FIG. 6.

As shown in FIG. 7, the RO unit 34 has (a) a first inlet zone at which a primary feed F is directed into the passages in the spacer member 66, i.e. between adjacent membrane envelopes 44, (b) a second inlet zone at which a secondary feed C is directed into the tube inlet section 40, the secondary feed then passing into the channels 54, and (c) an outlet zone at the tube outlet section 38 for receiving a mixture of permeate P, after it has passed into the membrane envelopes 44, and the secondary feed C, after it has passed through channels 54. One membrane envelope 44, together with its associated internal and external spacer members 66, 68 is shown in an unfolded, somewhat truncated aspect in FIG. 5 and in cross section in FIG. 6.

In operation of the illustrated RO unit 34 when used in a differential RO separation system of the form illustrated in FIGS. 3 and 8, feed water F flows under pressure along the unit through the passages formed in the spacer members 66. Permeate P is forced across the membranes 46, 48 into the interior of the membrane envelopes 44 from where it flows through holes 62, 64 in the tube 36. The TDS of the feed water, as it passes along the RO unit between adjacent membrane envelopes 44, increases along the length of the unit 34 as permeate crosses the membranes 44, 46 and so is lost from the feed water.

Concentrate C fed back from the feed side of a downstream RO unit (not shown) is directed into the tube inlet section 40, from where it flows along the channels 54, at the same time mixing with permeate P flowing across the membranes 46, 48 and into the channels 54. The mixture of permeate from the illustrated RO unit and concentrate fed back from the downstream RO unit exits at the tube outlet section 38. The mixing has the effect of increasing the dissolved solids content on the permeate side of the membranes 46, 48, thereby affecting the osmotic pressure gradient across the membranes. Because the flow of concentrate from the downstream RO unit is generally in a direction that is the reverse of the direction of flow of the primary feed, the dissolved solids concentration is higher at the output end of the RO unit than at the input end where the fed back concentrate has been substantially diluted by mixing with more and more solvent crossing the membranes. The TDS gradient along the length of the RO unit is therefore generally mirrored either side of the membrane. Consequently, the osmotic pressure along the length of the RO unit is generally constant.

As shown in FIG. 8, in an alternative membrane configuration to that shown in FIG. 7, a central tube 36 of a RO unit of the general form as that shown in FIGS. 5 and 6 has a water inlet section 40 and a water outlet section 38, the tube sections 38, 40 separated from each other by an internal barrier 42 which is more extensive than the corresponding barrier of the FIG. 7 embodiment. Front and back membranes 46, 48 of a membrane envelope are welded to each other at regions 52 to provide a series of water flow channels 54 from the inlet section 40 to the outlet section 38. The channels 54 extends from a region where the fourth membrane edges are sealed to the tube inlet section 40 to a region where the fourth membrane edges are sealed to the tube outlet section 38. The configuration of channels 54 ensures that all water flowing from the inlet section 40 to the outlet section 38 flows over generally the same distance. Moreover, as the water flows though the length of the path, it encounters feed water on the outside of the membrane envelope of gradually decreasing dissolved solids concentration. Because the fed back concentrate is acquiring permeate from outside the envelope in the course of its flow through the channels 54, the water inside the membrane envelope also has a gradually decreasing concentration towards the feed water input end. Of note in the FIG. 8 embodiment, permeate enters the membrane envelope at a comparatively lower flow rate than combined permeate and fed back concentrate exiting the envelope because fed back concentrate is progressively added along the length of the envelope. To keep water pressure in the envelope comparatively even, the incoming flow 86 is through a cross-sectional area that is comparatively smaller than the cross-sectional area of the exiting water flow 88.

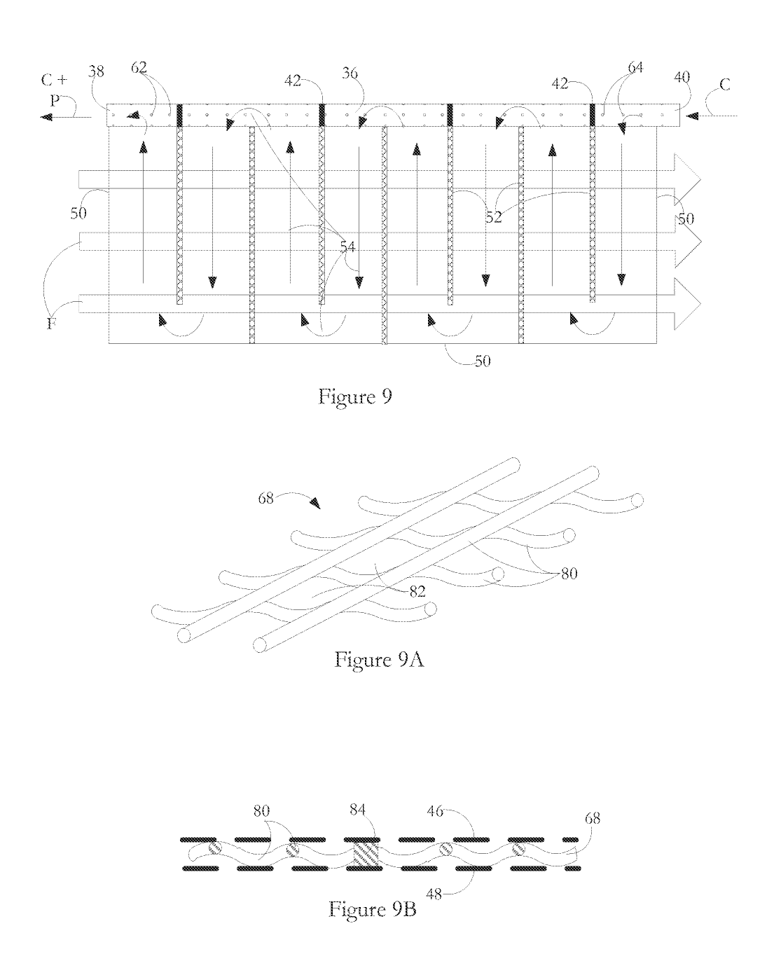

As shown in FIG. 9, in a further alternative membrane configuration to that shown in FIG. 7, a central tube 36 of a RO unit of the general form as that shown in FIGS. 5 and 6 has a water inlet section 40 and a water outlet section 38, the tube sections 38, 40 separated from each other by a series of internal barriers 42. Front and back membranes 46, 48 of a membrane envelope are welded to each other at regions 52 to provide a serpentine water flow path 54 from the inlet section 40 to the outlet section 38. The path 54 extends from a region where the fourth membrane edges are sealed to the tube inlet section 40 to a region where the fourth membrane edges are sealed to the tube outlet section 38. The configuration of path 54 ensures that all water flowing from the inlet section 40 to the outlet section 38 flows over generally the same distance. Moreover, as the water flows though the length of the path, it encounters feed water on the outside of the membrane envelope of gradually decreasing dissolved solids concentration. Because the fed back concentrate is acquiring permeate from outside the envelope in the course of its flow though the path 54, the water inside the membrane envelope also has a gradually decreasing concentration towards the feed water input end.

While the membrane envelope configurations shown in FIGS. 7, 8 and 9 present a convenient and practical way of routing water flows within the envelope, in an alternative embodiment of the invention, the spacer member 68 is configured to achieve a similar flow effect. Typically, as illustrated in FIG. 9A, such spacer members are hard plastic meshes with mesh elements 80 defining a regular array of apertures 82. The mesh elements 80 are dimensioned and shaped to keep front and back membranes (not shown) spaced apart, but to allow permeate water crossing the envelope membrane to percolate between adjacent apertures to a collection tube such as the tube 36 of FIG. 5. In a modified form as illustrated in FIG. 9B, a mesh 68 is formed with thickened barrier elements 84 which extend between nominal faces of the mesh and which, in the plane of the mesh, are located so as to provide a channel pattern of a form such as that shown in FIG. 7, 8 or 9. In use, the RO pressure results in a reasonably tight seal at the interface between the barrier elements 84 and the membranes 46, 48 so that the permeate water is confined to desired water flows as defined by the channel pattern.

While the coiled unit of FIGS. 5 and 6 presents a convenient and commercially valuable package for implementing the invention, a RO unit according to an embodiment of the invention can be implemented in alternative packages: such as, for example, a multi-layer flat pack of membranes or membrane envelopes and separators with appropriate circuit elements for obtaining the particular water flows to and from each side of the membranes as described with reference to FIG. 3. At its simplest, the invention contemplates a RO structure having a RO membrane with a feed water passage having an interface with one side of the membrane and a feedback water passage having an interface with the other side of the membrane. A feed water inlet is configured for directing the feed water under pressure along the feed water passage so that at least some of the feed water is driven as permeate across the RO membrane into the feedback passage. A feedback water inlet is configured for directing feedback water along the feedback water passage so that the fed back water receives permeate crossing the RO membrane into the feedback passage, the overall flow of the feed water being in a direction generally counter to the overall flow direction of the feedback water.

The phased RO separation system of FIG. 3 is configured to establish reduced operating pressures at the RO units in comparison with a single phase RO separation system. As previously indicated, this has an advantage in enabling less expensive equipment to be used for the pressure vessels, membranes and piping. Reduced pressures also enable reduced energy costs.

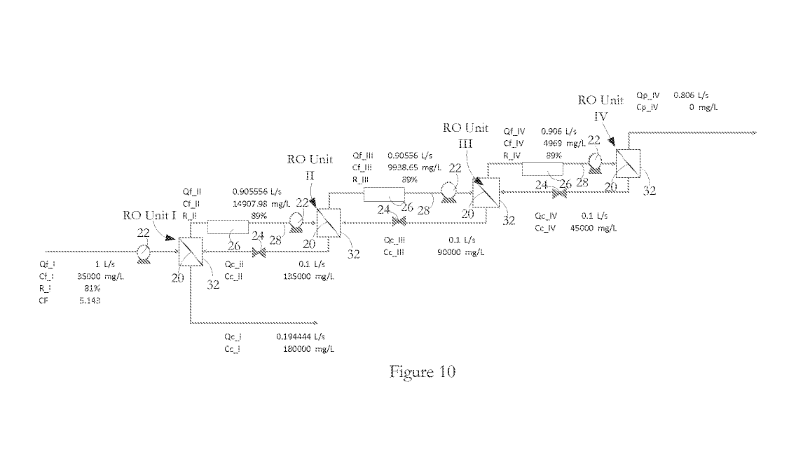

In another embodiment of the invention, the phased RO separation system illustrated in FIG. 10 is adapted to establish higher recovery of nominally pure water from a particular volume of seawater, produced water or other water containing a high level of dissolved solids. The operation of the RO unit system depicted is similar to the FIG. 3 system but, in this case, a 1 liter per second flow of seawater at the feed end of RO unit I results in a discarded concentrate of 0.125 liters per second from RO unit I and the recovery of 0.875 liters per second of nominally pure water permeate from RO unit IV. The design of a phased RO separation system according to the invention contemplates other permutations of osmotic pressure gradient and recovery depending on desired system objectives.

Usually, the concentrate fed back from a downstream RO unit to an upstream RO unit is taken from a region of highest TDS concentration of the downstream unit. However, the differential RO system can be operated to feed back concentrate from an intermediate position along the downstream RO unit. This can be done, for example, in response to a monitored drop in TDS of the initial feed water so as to preserve the osmotic pressure across the membrane at a fixed level.

The differential RO separation systems described can be used both for reverse osmosis and nanofiltration. Nanofiltration is essentially reverse osmosis using ‘loose’ membranes which allow leakage of monovalent ions (+/−1 charge) such as sodium, potassium, chlorides, sulfates, etc., through the membranes to a greater degree than RO, while still rejecting multivalent ions (+/−>1 charge) such as calcium and magnesium to a high degree. While characterized by less dissolved solids rejection, nanofiltration membranes are of advantage in some situations because they can be operated at relatively lower pump energy than standard RO membranes. If leakage of dissolved solids across the membrane reaches a steady state this may be acceptable. But if the dissolved solids level on the permeate side of the membrane continues to arise, more dilution and purging than reasonable may be required.

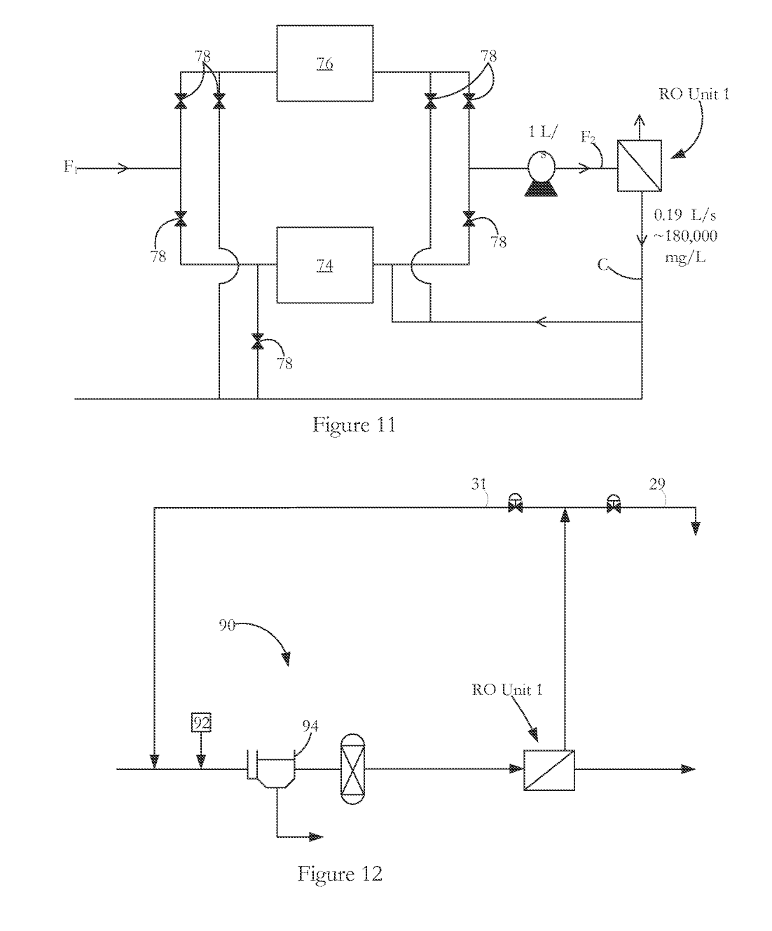

The differential RO process described has applications additional to the desalination application specifically described. The process can, for example, be used in treating contaminated water from hydraulic fracturing operations. Hydraulic fracturing (“fracking”) is the process of drilling and injecting fluid at high pressure into certain types of rock containing tiny pockets of oil and gas for the purposes of fracturing the rock to release and recover the oil and gas. Current fracking processes result in large amounts of contaminated water. This consists chiefly of produced water, which is water that is naturally present in the rock but which is displaced and migrates up to the surface during operation of the well, and flowback water, which is water and associated dissolved materials that have been used in fracturing the rock and that migrate back to the surface during operation of the well and for a short time after drilling and recovery are finished. Both waters have high levels of dissolved solids. Because produced and flowback water generally contain a large quantity and variety of contaminants, there is an increased risk of membrane blockage compared to the treatment of relatively cleaner waters by the differential RO process. In this situation, as shown in the schematic view of FIG. 11, it is useful to twin the differential RO process previously described with a pre-treatment phase in which the contaminated fracking water F₁ is first treated in an ion exchange plant.

Ion exchange (IE) is a process commonly used in water purification. Ion exchangers generally use ion exchange resins which have active sites. In one form of cationic exchanger, the exchange resin is used to replace double-charged monatomic ions such as magnesium Mg²⁺ and calcium Ca²⁺ with sodium Na⁺. In a receptive state, the resin has sodium Na⁺ at its active sites. When the resin is in contact with a solution containing magnesium Mg²⁺ and calcium Ca²⁺ but only a small amount of sodium Na⁺, the magnesium Mg²⁺ and calcium Ca²⁺ cations ions preferentially migrate out of solution to the active sites to replace the sodium Na⁺ at the sites. The resin is subsequently reactivated by subjecting it to a washing process in a solution containing high concentrations of sodium Na⁺. In the washing process, the sodium Na⁺ cations displace the magnesium Mg²⁺ and calcium Ca²⁺ cations at the active sites. It is desirable for efficient resin washing to have a reactivation solution that has very high sodium Na⁺ concentration. In this respect, one result of the differential RO process when operated with the operating parameters of, for example, the FIG. 10 embodiment is a concentrate from the input side of the first RO unit membrane which has very high dissolved salt concentration—of the order of 100,000 to 280,000 mg/L in the exemplary embodiment. The high dissolved salt concentration is ideal for efficient washing of IE resins that have previously been used to extract heavier metal cations such as magnesium Mg²⁺ and calcium Ca²⁺. The RO process described, when coupled with such an ion exchange pre-treatment, provides an effective dual-process circuit.

As shown in FIG. 11, valves 78 are configured so that at a first cationic ion exchange vessel 76, water such as hydraulic fracturing produced water F₁, is treated to remove magnesium Mg²⁺ and calcium Ca²⁺ cations from solution by having the cations displace sodium Na⁺ cations in a strong acid cation exchange resin such as RESINTECH® CG10 available from RESINTECH INC. The treated water is then taken as an input F₂ to RO Unit I.

The valves 78 are also configured so that concentrate C at very high dissolved salts level—180,000 mg/L in this example—is taken from RO unit I of the differential RO system of FIG. 10 to a second cationic ion exchange vessel 74. At the cationic exchange vessel 74, the active medium in the vessel 74 is washed in the concentrate from RO unit I. A backwash cycle is used before regeneration to remove solids on the top of the bed and to condition the bed to prevent channeling of water flowing up through the bed. Following backwash, the resin is then subjected successively to the brine regeneration, a slow flush with clean water or process water to slowly push the brine out of the vessel, and then a fast rinse with process or clean water to evacuate all of the brine. As a result of the regeneration process, heavier metal cations such as magnesium Mg²⁺ and calcium Ca²⁺ are displaced at active sites in the resin by sodium Na⁺ cations. The pre-treatment of input water at cationic exchange vessel 76 and the active medium washing at cationic exchange vessel 74 are continued until the active medium in exchange vessel 76 is exhausted, at which point, the valves 78 are opened or closed as appropriate to reverse the roles of the two exchangers 74, 76.

Although ion exchange pre-treatment of feed waters has been described in the context of a cation exchange process, a strong base anion exchange vessel can alternatively be used in conjunction with high chloride concentration in the concentrate stream from the differential RO phase. A suitable active medium is RESINTECH® CG10 available from RESINTECH INC.

The IE pre-treatment of the feed water before it is subjected to the differential reverse RO process acts to reduce the extent to which passage of feed water results in deposited scale in the vessels and pipes used in the differential RO process.

Alternative feed water pre-treatment units can be used to remove certain contaminants before the feed water is subjected to the differential RO process.

For example, a suitable pre-treatment plant can be of the form shown in U.S. Pat. No. 4,983,301 (Method and apparatus for treating fluids containing foreign materials by membrane filter equipment, Szucz et al.) As described in this patent, feed water is fed to the inlet of a membrane filter equipment which outputs (a) a concentrate containing more dissolved solids and other contaminants than the feed water, and (b) a permeate containing less dissolved solids and contaminants than the feed water. Concentrate leaving the membrane filter pack is fed back to the inlet of the membrane filter pack with the fluid being recirculated under high pressure until a predetermined concentration value is reached. At that point, the concentrated fluid is discharged and new feed water is introduced. A continuous operation is achieved either by using two vessels which are arranged in the fluid treatment circuit such that they can be switched over periodically or by periodically back-flushing the membrane pack within a closed system. In the context of the present invention, the permeate is fed to the first stage of the differential RO plant.

In another pre-treatment example, as shown in FIG. 12, a precipitative softening sub-system 90 is installed upstream of the first stage, RO unit 1, of the differential RO system. At the softener, certain reagents such as calcium hydroxide (Ca(OH)₂) 92 are added to the feed water to cause the pH to rise. The increase in pH reduces the solubility of many of the sparingly soluble salts that may be present in the feed water, such as calcium carbonate (CaCO₃) and magnesium hydroxide (Mg(OH)₂), causing them to precipitate. The precipitate flocculates and settles within the clarification vessel 94, separating the solid-rich fraction from the treated liquid effluent.

Additional reagents can be added depending on the feed water chemistry and the compounds to be precipitated, as by adding a coagulant such as polyaluminum chloride to aid the removal of antiscalant chemicals. The precipitative softener can also be designed and operated to facilitate the coprecipitation of dissolved silica.

The precipitative softening pre-treatment of the feed water before it is subjected to the differential reverse RO process acts to reduce the concentrations of compounds that limit the achievable recovery through the differential RO process. The concentrate being rejected from the differential RO is rich in sparingly soluble salts and TDS. Some fraction 29 of the differential RO concentrate is removed from the process, while some fraction 31 of the concentrate is recycled back upstream of the precipitative softening pre-treatment sub-system. Additional treatment of the concentrate recycle stream may be performed to remove antiscalants and sparingly soluble salts in the concentrate stream before it is diluted with new incoming feed water.

This combination of the precipitative softening as pre-treatment to the differential RO process, including some fraction of differential RO concentrate recycling, acts to achieve higher TDS concentration than could be achieved with the differential RO process alone or that could be achieved with a conventional RO system.

Other variations and modifications will be apparent to those skilled in the art. The embodiments of the invention described and illustrated are not intended to be limiting. The principles of the invention contemplate many alternatives having advantages and properties evident in the exemplary embodiments.

What is claimed is:

1. A water treatment system comprising a plurality of concatenated reverse osmosis (RO) units each RO unit having a RO membrane, each unit having a feed input of water to be treated to one side of the associated membrane, a sub-system for applying RO pressure to the feed water to produce a concentrate at said one side of the membrane and permeate at the other side of the membrane, and a circuit configured to direct concentrate from the one side of at least one downstream RO unit membrane to the other side of an upstream RO unit membrane to mix the directed concentrate from the downstream RO unit with the permeate of the upstream RO unit at the other side of the upstream RO unit, and to direct the mixed concentrate and permeate from the upstream RO unit as the feed input to the downstream RO unit.

2. A system as claimed in claim 1, further comprising a monitoring unit for monitoring the osmotic pressure gradient across at least one RO unit.

3. A system as claimed in claim 2, further comprising a control unit for adjusting the flow of concentrate fed back from the downstream unit to alter the osmotic pressure across the upstream RO unit membrane.

4. A system as claimed in claim 3, the control unit having an input from the monitoring unit whereby to make the flow rate of concentrate fed to the upstream RO unit from the downstream RO unit dependent on the osmotic pressure gradient across the membrane of the upstream RO unit.

5. A system as claimed in claim 3, the control unit having an input from the monitoring unit whereby to make the dissolved solids concentration of concentrate fed to the upstream RO unit from the downstream RO unit dependent on the osmotic pressure gradient across the membrane of the upstream RO unit.

6. A system as claimed in claim 5, the control unit having an outlet from said one side of a membrane of the downstream unit, the outlet having a position adjustment mechanism to alter the position of the outlet and thereby alter the dissolved solids concentration of the fed back concentrate.

7. A system as claimed in claim 1, further comprising at least one concentrate routing passage at said other side of the membrane of the upstream RO unit to receive the fed back concentrate from the downstream RO unit and to route the concentrate past the membrane in a direction generally counter to a direction of flow of the water being treated at said one side of the upstream RO unit membrane.

8. A system as claimed in claim 1, further comprising a module for lowering dissolved solids content in the permeate side of the membrane of at least one of the RO units to maintain the dissolved solids content on the permeate side of the membrane of the at least one RO unit within a target range.

9. A system as claimed in claim 1, the number of RO units and the concentration and flow rate of fed back concentrate selected to maintain osmotic pressure at the RO units below a predetermined threshold.

10. A system as claimed in claim 1, the number of RO units, the applied RO pressure, and the concentration and flow rate of fed back concentrate selected to obtain system recovery above a predetermined threshold.

11. A system as claimed in claim 1, the membranes configured for nanofiltration.

12. A system as claimed in claim 1, further comprising a subsystem for pre-treating the water to be treated in an ion exchange medium and for periodically washing the ion-exchange medium in concentrate from the first of the concatenated RO units.

13. A system as claimed in claim 1, further comprising a subsystem for pre-treating in a precipitative softener subsystem the water to be treated in the concatenated RO system, the precipitative softener subsystem operable to precipitate and remove at least one of calcium and magnesium salts from the water to be treated in the concatenated RO units.

14. A method for treating water using a plurality of concatenated reverse osmosis (RO) units, each RO unit having a RO membrane, the method comprising at each RO unit, feeding a feed input of water to be treated to one side of the associated membrane, applying RO pressure to the feed water to produce concentrate at said one side of the membrane and permeate at the other side of the membrane, and directing concentrate from the one side of at least one downstream RO unit to the other side of the membrane of an upstream RO unit to mix the directed concentrate from the downstream RO unit with the permeate of the upstream RO unit, and directing at least a part of the mixed concentrate and permeate as the feed input to the downstream RO unit.

15. A method as claimed in claim 14, further comprising monitoring the osmotic pressure gradient across at least one of the RO units.

16. A method as claimed in claim 14, further comprising adjusting the flow of concentrate fed back from the downstream RO unit to the upstream RO unit to alter the osmotic pressure across the upstream RO unit membrane.

17. A method as claimed in claim 16, the adjusting the flow of concentrate from the downstream RO unit comprising adjusting the flow rate of the concentrate.

18. A method as claimed in claim 16, the adjusting the flow of concentrate from the downstream RO unit comprising adjusting the dissolved solids concentration of the concentrate.

19. A method as claimed in claim 16, further comprising adjusting the position of an outlet from said one side of the membrane of the downstream unit thereby to alter the dissolved solids concentration of the fed back concentrate.

20. A method as claimed in claim 16, further comprising feeding the concentrate from the downstream RO unit past the other side of the upstream RO unit membrane in a direction generally counter to a direction of flow of the water being treated at said one side of the upstream RO unit membrane.

21. A method as claimed in claim 14, further comprising lowering dissolved solids content in the permeate side of the membrane of at least one of the RO units to maintain the dissolved solids content on the permeate side of said membrane within a target range.

22. A method as claimed in claim 14, further comprising setting the number of RO units and the concentration and flow rate of fed back concentrate to maintain osmotic pressure at the RO units below a predetermined threshold.

23. A method as claimed in claim 14, further comprising setting the number of RO units, the applied RO pressure, and the concentration and flow rate of fed back concentrate so as to obtain system recovery above a predetermined threshold.

24. A method as claimed in claim 14, wherein the membranes are configured for nanofiltration.

25. A method as claimed in claim 14, further comprising pre-treating the water to be treated in an ion exchange medium and periodically washing the ion-exchange medium in concentrate from the first of the concatenated RO units.

26. A method as claimed in claim 14, further comprising pre-treating in a precipitative softener the water to be treated in the concatenated RO, thereby to precipitate and remove at least one of calcium and magnesium salts.

27. A method as claimed in claim 12, wherein the water to be treated fed to an initial one of the concatenated RO units is one of seawater, produced water and flowback water.
